(19) United States
(12) Patent Application Publication
(10) Pub. No.: US 2019/0213633 A1
(43) Pub. Date: Jul. 11, 2019

(54) SYSTEM AND METHOD FOR FACILITATING CLICKABLE LINKS EMBEDDED DIGITAL ASSETS USING A BLOCKCHAIN LEDGER

(71) Applicant: Michael Stephen Kokernak, Boston, MA (US)

(72) Inventor: Michael Stephen Kokernak, Boston, MA (US)

(21) Appl. No.: 15/866,497

(22) Filed: Jan. 10, 2018

(51) Int. Cl. G06Q 30/02; G06Q 20/38; H04W 12/02; G06F 21/62

(52) U.S. Cl. CPC G06Q 30/0253; G06Q 30/0277; G06Q 50/01; H04W 12/02; G06F 21/62; G06Q 20/3829

(57) ABSTRACT

A system and method relates to a decentralized infrastructure and system including smart contracts to facilitate clickable links embedded in a multimedia content using blockchain ledgers. A computer-implemented method of facilitating clickable link embedded in a multimedia content using a decentralized blockchain ledger. The computer-implemented method receives the multimedia content that includes the clickable link embedded in the multimedia content, retrieves one or more web links upon clicking of the clickable link that enables a user to view an advertised product and/or enables activation of one or more tokens, determines one or more interaction events, performed by the user, while viewing the advertised product and/or while retailing using the one or more tokens, generates a registration entry associated with the one or more interaction events for addition to the decentralized blockchain ledger, and distributes the registration entry in a blockchain to a plurality of nodes in the decentralized blockchain ledger management system.

### FIELD OF THE INVENTION

The present disclosure relates generally to the field of advertisement, and more particularly, to a decentralized infrastructure and system including smart contracts to facilitate clickable links embedded in a multimedia content using blockchain ledgers.

### BACKGROUND

The background description includes information that may be useful in understanding present invention. It is not an admission that any of the information provided herein is prior art or relevant to the presently claimed invention, or that any publication specifically or implicitly referenced is prior art.

As Internet bandwidth capabilities increase, on-demand video continues to grow in popularity. The concurrent growth in social media technology facilitates the generation of vast amounts of meta-content. Such meta-content often includes postings on social media websites (e.g., Twitter, Facebook, MySpace), commenting or reviewing on-demand video that is available for download via the Internet.

Infrastructure choices for the distribution of digital assets have significantly changed in recent years. From unidirectional networks controlled by few that had control of airwaves, cables and satellites to a general purpose, shared Internet infrastructure that allows unrestricted two-way peer-to-peer communication. From playback hardware that is dependent on a few manufactures that create playback devices for TV signals and media to general-purpose computers that allow use of software that enables media playback. From large-scale investment required to produce and publish media, to ubiquitous hardware and software to create, edit and distribute content in form such as text, video and audio. However, the issuing, maintenance and trade of resulting assets is still limited to the control of few distribution systems that manage the commerce, usage and control the playback infrastructure in a centralized fashion. Examples include Apple iTunes, Google Play, Netflix, BluRay, DECE UltraViolet, Disney Movies Anywhere, TV and VOD service and other content ecosystems.

However, with the advent of internet and technology, the usage of conventional TVs is decreasing day by day and accordingly the advertisers investments in advertising dedicatedly on the TVs is also decreasing on daily basis. For example, according to Nielsen Holdings, in the United States, as video channels proliferate, more and more viewers are watching video more than 4.5 hours a day. Still, advertisers are facing a serious problem, since nearly 83 percent (83%) of their viewers are skipping commercials nearly all of the time and hence becoming less accountable for the world's biggest advertisers. Thus there exists a need for an accountable advertising solution that works within the TV industry's current technology.

Online advertising may be an important source of revenue for enterprises engaged in electronic commerce. A number of different types of web page based online advertisements (ads) are currently in use, along with various associated distribution requirements, advertising metrics, and pricing mechanisms. Processes implemented with technologies such as Hypertext Markup Language (HTML) and Hypertext Transfer Protocol (HTTP) enables a web page to be configured to contain a location for inclusion of an advertisement (ad). A page may not only be a web page, but any other electronically created page or document. An advertisement may be selected for display within the page each time the page is requested, for example, by a browser or server application.

Hyperlinks are widely used in electronic text documents and typically implemented with a browser (i.e., web browser). A hyperlink may be considered as a connection between an element, such as a word, phrase, symbol or object in a document, such as a hypertext document, with a different element in the same document, another document, file or script. The hyperlink may be activated by a user clicking on the hyperlink through an interactive user device such as mouse. When the user clicks on the hyperlink, the browser may be redirected to the clement or other document. The concept of hyperlink may also be used on images, particularly as a “map” tag on images in hypertext markup language. For example, when a user clicks on a region having the map tag, the browser is redirected to the linked webpage.

Traditional online advertising includes static displays of text or images on a page. However, the content available on the Internet and in web pages has become increasingly dynamic. For example, the viewing of video content online is becoming more common as consumers have access to higher bandwidth and spend more time online. Traditional online advertising has targeted users of static web pages. However, the viewing habits for online videos are different from usual text reading of web pages online. The attention of the user is focused on the screen where the video plays as compared to the viewing of scrolling text, so intermittent advertising that breaks up a video may be disruptive. Accordingly, there is a need for advertisers to provide non-intrusive advertisements to users who are viewing videos and other multimedia online.

The implementations described above regarding the concept of hyperlinks have been in reference to static documents. In other words, a hyperlink exists on documents that do not change. Browsers and other applications not only are supporting static electronic documents, but may also support video. Therefore, it would be desirable to implement the hyperlink concept with elements in a video or video stream. However, the implementation of hyperlinks with video may present several problems, including associating a hyperlink to a moving target object in a video frame. Furthermore, a hyperlink in video may be distractive to the viewing experience.

Accordingly, given the extensive consumer acceptance and widespread interest in such videos or multimedia contents, there is always a need for better ways to commercialize the economic value generated from these video or multimedia contents. Also, advertisers are particularly worry in using new technologies that do not provide the most secure methods available to protect their customer data.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all groups used in the appended claims.

### SUMMARY

The present disclosure relates generally to the field of advertisement, and more particularly, to a decentralized infrastructure and system including smart contracts to facilitate clickable links embedded in a multimedia content using blockchain ledgers.

Embodiment of the present disclosure provides a system and method or a platform that incorporates a blockchain technology with a click-through metrics to return accountability back into the television platform. The system and method or the platform can help to capitalize on the viewer's migration from the cable set-top box to mobile and browser viewing.

An aspect of the present disclosure relates to a computer-implemented method of facilitating clickable link embedded in a multimedia content using a decentralized blockchain ledger. The computer-implemented method receives the multimedia content that includes the clickable link embedded in the multimedia content, retrieves one or more web links upon clicking of the clickable link that enables a user to view an advertised product and/or enables activation of one or more tokens, determines one or more interaction events, performed by the user, while viewing the advertised product and/or while retailing using the one or more tokens, generates a registration entry associated with the one or more interaction events for addition to the decentralized blockchain ledger, and distributes the registration entry in a blockchain to a plurality of nodes in the decentralized blockchain ledger management system.

An aspect of the present disclosure relates to a computing device to facilitate clickable link embedded in a multimedia content using a decentralized blockchain ledger. The computing device includes a receiving module to receive the multimedia content that includes the clickable link embedded in the multimedia content, a retrieving module to retrieve one or more web links upon clicking of the clickable link that enables a user to view an advertised product and/or enables activation of one or more tokens, a determining module to determine one or more interaction events performed by the user while viewing the advertised product and/or while retailing using the one or more tokens, a generation module to generate a registration entry associated with the one or more interaction events for addition to the decentralized blockchain ledger, and a distributing module to distribute the registration entry in a blockchain to a plurality of nodes in the decentralized blockchain ledger management system.

An aspect of the present disclosure relates to a system having a clickable link embedding device configured to embed a clickable link in a multimedia content, and a computing device to facilitate clickable link embedded in the multimedia content using a decentralized blockchain ledger. The computing device can receives the multimedia content that includes the clickable link embedded in the multimedia content, retrieves one or more web links upon clicking of the clickable link that enables a user to view an advertised product and/or enables activation of one or more tokens, determines one or more interaction events, performed by the user, while viewing the advertised product and/or while retailing using the one or more tokens, generates a registration entry associated with the one or more interaction events for addition to the decentralized blockchain ledger, and distributes the registration entry in a blockchain to a plurality of nodes in the decentralized blockchain ledger management system.

Various objects, features, aspects and advantages of the inventive subject matter will become more apparent from the following detailed description of preferred embodiments, along with the accompanying drawing figures in which like numerals represent like components.

### BRIEF DESCRIPTION OF DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure. The diagrams are for illustration only, which thus is not a limitation of the present disclosure, and wherein:

FIG. 1 illustrates a network implementation of a proposed clickable TV, in accordance with an exemplary embodiment of the present disclosure.

FIG. 2 illustrates exemplary functional modules of the proposed clickable TV, in accordance with an exemplary embodiment of the present disclosure.

FIG. 3 illustrates exemplary working of the proposed clickable TV, in accordance with an exemplary embodiment of the present disclosure.

FIG. 4 illustrates exemplary links of provided by the proposed clickable TV for any digital asset/multimedia content, in accordance with an exemplary embodiment of the present disclosure.

FIG. 5 illustrates an exemplary installation of the proposed clickable TV, in accordance with an exemplary embodiment of the present disclosure.

FIG. 6 illustrates an exemplary flow diagram representing method performed by the proposed clickable TV, in accordance with an exemplary embodiment of the present disclosure.

### DETAILED DESCRIPTION OF THE INVENTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

In the following description, numerous specific details are set forth in order to provide a thorough understanding of embodiments of the present invention. It will be apparent to one skilled in the art that embodiments of the present invention may be practiced without some of these specific details.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, and firmware and/or by human operators.

Embodiments of the present invention may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more machine-readable storage media containing the code according to the present invention with appropriate standard computer hardware to execute the code contained therein. An apparatus for practicing various embodiments of the present invention may involve one or more computers (or one or more processors within a single computer) and storage systems containing or having network access to computer program(s) coded in accordance with various methods described herein, and the method steps of the invention could be accomplished by modules, routines, subroutines, or subparts of a computer program product.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise.

Exemplary embodiments will now be described more fully hereinafter with reference to the accompanying drawings, in which exemplary embodiments are shown. These exemplary embodiments are provided only for illustrative purposes and so that this disclosure will be thorough and complete and will fully convey the scope of the invention to those of ordinary skill in the art. The invention disclosed may, however, be embodied in many different forms and should not be construed as limited to the embodiments set forth herein. Various modifications will be readily apparent to persons skilled in the art.

The general principles defined herein may be applied to other embodiments and applications without departing from the spirit and scope of the invention. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure). Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

Thus, for example, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named element.

Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims.

All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Various terms as used herein are shown below. To the extent a term used in a claim is not defined below, it should be given the broadest definition persons in the pertinent art have given that term as reflected in printed publications and issued patents at the time of filing.

The present disclosure relates generally to the field of advertisement, and more particularly, to a decentralized infrastructure and system including smart contracts to facilitate clickable links embedded in a multimedia content using blockchain ledgers.

Embodiment of the present disclosure provides a system and method or a platform that incorporates a blockchain technology with a click-through metrics to return accountability back into the television platform. The system and method or the platform can help to capitalize on the viewer's migration from the cable set-top box to mobile and browser viewing.

An aspect of the present disclosure relates to a computer-implemented method of facilitating clickable link embedded in a multimedia content using a decentralized blockchain ledger. The computer-implemented method receives the multimedia content that includes the clickable link embedded in the multimedia content, retrieves one or more web links upon clicking of the clickable link that enables a user to view an advertised product and/or enables activation of one or more tokens, determines one or more interaction events, performed by the user, while viewing the advertised product and/or while retailing using the one or more tokens, generates a registration entry associated with the one or more interaction events for addition to the decentralized blockchain ledger, and distributes the registration entry in a blockchain to a plurality of nodes in the decentralized blockchain ledger management system.

An aspect of the present disclosure relates to a computing device to facilitate clickable link embedded in a multimedia content using a decentralized blockchain ledger. The computing device includes a receiving module to receive the multimedia content that includes the clickable link embedded in the multimedia content, a retrieving module to retrieve one or more web links upon clicking of the clickable link that enables a user to view an advertised product and/or enables activation of one or more tokens, a determining module to determine one or more interaction events performed by the user while viewing the advertised product and/or while retailing using the one or more tokens, a generation module to generate a registration entry associated with the one or more interaction events for addition to the decentralized blockchain ledger, and a distributing module to distribute the registration entry in a blockchain to a plurality of nodes in the decentralized blockchain ledger management system.

An aspect of the present disclosure relates to a system having a clickable link embedding device configured to embed a clickable link in a multimedia content, and a computing device to facilitate clickable link embedded in the multimedia content using a decentralized blockchain ledger. The computing device can receives the multimedia content that includes the clickable link embedded in the multimedia content, retrieves one or more web links upon clicking of the clickable link that enables a user to view an advertised product and/or enables activation of one or more tokens, determines one or more interaction events, performed by the user, while viewing the advertised product and/or while retailing using the one or more tokens, generates a registration entry associated with the one or more interaction events for addition to the decentralized blockchain ledger, and distributes the registration entry in a blockchain to a plurality of nodes in the decentralized blockchain ledger management system.

In an aspect, a video (also interchangeably referred to as “multimedia content” which can include any or a combination of different content forms such as text, audio, images, animations, video and interactive content) is provided that includes a clickable link. Upon activation of the link, a graphical interface is provided for viewing an advertised product and/or for the activation of one or more tokens (cryptocurrencies like ethereum or bitcoin) to purchase/buy the advertised product. The graphical interface is pre-populated with an address for the video and a keyword associated with the video.

As examples, the clickable link may include the keyword. The keyword may be a hashtag. The keyword may be preceded by a # symbol. The video may be displayed on FunnyorDie or YouTube or as an advertisement on TV. The advertised product may be displayed any online food and grocery store. The clickable link may direct the use to an online food and grocery store or an advertiser's dedicated web site where a user can buy the advertised product. The clickable link may cover a portion of the video. The clickable link may be activated by clicking on the link using a pointing device. The clickable link may be activated by clicking on the video using a pointing device. The graphical interface may be pre-populated according to: address #keyword; where address is the address for the video, and keyword is the keyword associated with the video. The keyword may be searchable.

In an aspect, a video according to the present disclosure includes an embeddable keyword link that facilitates consistent keyword usage across social media or normal English postings. In an example, a keyword link may be embedded into the video itself, such that when the video or a portion of the video is clicked (e.g., the portion of the video that includes the keyword acts as a link), a graphical interface for generating a advertised product posting may be provided that is pre-populated with certain data such as a keyword associated with the video.

In an aspect, a link may be embedded into a video using a variety of mechanisms. For example, certain websites provide functionality for incorporating links into a video (e.g., LinkedTube.com). By entering data related to the video and the link, code may be generated that facilitates embedding of the video into a webpage with the embedded keyword link. The entered data may include the address of the video, the content to be displayed on the video for the link (e.g., the hashtag or keyword), and the address to which the user should be directed when clicking on the link (e.g., the social media or advertised products graphical interface that is pre-populated with the video address and the embedded keyword). Other video hosting services, such as YouTube, may offer similar functionality for embedding links into videos.

In an aspect, the registration entry is generated based on the one or more interaction events. In another aspect, the registration entry is secured using a combination of the one or more tokens and one or more encryption keys ensuring privacy and security of the user's data and an advertiser's data.

In an aspect, the clickable link enables the user to request information associated with the advertised product from the advertiser.

In an aspect, an advertiser pays a publisher based at least on the one or more interaction events. In another aspect, an advertiser updates the one or more web links and/or the advertised product based at least on the one or more interaction events.

In an aspect, the clickable link embedded in the multimedia content is configured to operate in a LIVE environment and/or a desktop virtual reality (DVR) environment.

In an aspect, the user can bookmark the web links that enables the user to view the advertised product.

In an aspect, the one or more interaction events are associated with at least a click stream data.

In an aspect, the one or more interaction events are associated with at least an e-commerce sales data.

In an aspect, the system and method according to the present disclosure can enable to determine one or more paths of the one or more tokens to match with e-commerce sales in order to determine return on investment (ROI).

In an aspect, the one or more tokens are cryptocurrencies. In another aspect, the one or more tokens have an associated pre-defined value.

In an aspect, the cryptocurrencies can be Ethereum, Bitcoin, ripple, dash, Litecoin, Dash, Monero, Zcash, and the like.

In an aspect, the one or more tokens are transferable. In another aspect, the one or more tokens are sellable on open exchanges and are usable to purchase goods and services through clickable link embedded in the multimedia content.

In an aspect, the one or more web links are associated with and/or are hosted by advertisers. In another aspect, the multimedia content is provided by the advertiser.

In an aspect, the system and method according to the present disclosure can perform digital facilitation, verification, or enforcement of negotiation or performance of a contract between the use and advertisers and/or a publisher using a smart contract.

Many embodiments of the present invention include a decentralized, distributed digital ledger that documents the transfer (also called licenses) from creators to end-users (also called licensees, users, end users or consumers) and/or between end users, referred to here as a blockchain ledger. In many embodiments, the ledger is stored, modified and maintained on several independent nodes and trust is established by rules on the format on the ledger rather than the source and origin of the information. In such embodiments, the rules are established with cryptographic principles that make modification of the data difficult. In further embodiments, no centralized third party of trust is needed for transactions involving license distribution, selling, data-tracking, metrics analytics, and/or auditing. In many embodiments, content creators (or copyright owners) are motivated to verify and confirm past licenses, document and log transactions, and solve challenges which provides the right to register a new creation (also called work, asset or content) in the blockchain ledger in return. In certain embodiments, creations include, but are not limited to, text, images, audio, and video, but can also include any licensable work that can be represented in digital form. A copy of a creation may be referred to as a piece of content. In many embodiments, a blockchain ledger having a record of a creation evidences that a creator created a media work and additional transactions in the blockchain ledger can provide a right for a user account or playback device to access and/or play back a piece of content that is a representation of that creation.

In a number of embodiments, the blockchain ledger is stored and verified in a decentralized fashion, i.e. replicated to different entities (that may be referred to as nodes) that are separately able to verify past transactions. In further embodiments, the ownership of a creation as well as license can be proven using cryptographic principles. In many embodiments, the chaining of transactions, cryptographic verification and the hash challenge utilizes a blockchain system based on principles and/or mechanisms similar to those in the art of cryptocurrency. Techniques for managing blockchains in the context of currency are described in “Bitcoin: A Peer-to-Peer Electronic Cash System” by Satoshi Nakamoto, published in 2008, the disclosure of which relevant to blockchain management is hereby incorporated by reference in its entirety.

A blockchain can typically be understood to be a distributed decentralized database that maintains a continuously-growing list of records called blocks. Each block contains a link to a previous block generated using a hash of the previous block, and often includes mechanisms for protection from tampering and revision. The blockchain is distributed so that copies are replicated among participating nodes in the system. As transactions are added the copies are extended and the longest chains are trusted that follows a rule and provides according proof of work or stake. Nodes may be any of a variety of hardware devices or playback devices, such as, but not limited to, servers, workstations, desktop computers, mobile devices, and/or tablets, configured to participate in the decentralized digital system as discussed further below. More specifically, nodes can include blockchain management devices and playback devices as described in greater detail further below.

In some embodiments, pieces of content are interpreted and used with a platform (which can be a playback device, viewer, app, application, client or decoder as will be discussed further below) that can play back many forms of media using a player application. In certain embodiments, identifying the platform can be an important tool to limit piracy of assets by using encryption and/or other mechanisms that can limit creations to specific platforms. The creator of the work can authorize (e.g., by cryptographically linking) specific platforms to a creation by registering it in the blockchain ledger. In many more embodiments, the blockchain ledger may be utilized to enable a platform to verify and enforce limitations or usage rules imposed on the content by the license such as (but not limited to): limiting the number of playbacks, limiting the transfer of the license, and limiting the length of time allowed for a playback to occur.

Usage rules may be determined by the creator by issuing usage rules and/or limiting approved platforms. In yet additional embodiments, licensing and other transactions can be accompanied with financial transactions for purchase on another platform, including cash, credit card, Bitcoin or any of a variety of other forms of electronic payment system. The financial transactions can be independent of the registration and execution of the ledger. Alternatively blockchain transactions can be referenced from the ledger or smart contracts can bind payment and licensing. Systems and methods for performing quality based streaming of content in accordance with various embodiments of the invention are discussed further below.

In an exemplary embodiment, a decentralized digital ledger system can allow creators to increase control of their content, reduce transaction costs and friction, i.e., the ability to get to market faster and with less cost. This can be accomplished by removing the need for middlemen distributors, subscriber management systems, centralized and proprietary management systems, network infrastructure, etc. A decentralized digital ledger system for management can increase revenue and payment security for content owners across a fragmented pool of operators and solutions. The decentralized digital ledger system can allow for a “publish-once” methodology, eliminating the need for walled gardens of content and payment solutions. The ledger system can also help establish intellectual property by creating an exact and virtually immutable record that can show a work's registration date and rightful owner. Additionally, due to the fact that the smart contracts in the ledger do not need to be limited by legal and geographical boarders the ledger allows content creators to license works globally and the system can be used where there may not be a proper payment system or trusted agent to facilitate a standard licensing transaction. Due to the static and public nature of a ledger blockchain, creators can easily calculate proper royalty payments, as well as track additional marketing data.

In many embodiments, the system has a further benefit of being pseudonymous, i.e., the content transaction cannot be traced to an individual or location but a pseudonym (key) and are therefore protecting consumer's privacy.

In an exemplary embodiment, the decentralized digital ledger system can include a blockchain management device that can communicate with one or more other nodes via a network. Additionally, the decentralized digital ledger system includes a variety of playback devices that may run on hardware such as personal computers, set-top boxes, mobile phones, personal computing devices, some of which may communicate on the network via a wireless access point.

In an exemplary embodiment, the decentralized digital ledger system can include a blockchain management device configured to create an initial genesis block in a ledger file. This new ledger file may be transmitted over the network to other nodes including playback devices and other blockchain management devices. In many embodiments, the decentralized digital ledger system is decentralized in that entire copies of a particular ledger file are stored on multiple nodes. In other embodiments, some copies may be a pruned copy of the ledger file. Participating nodes may utilize a copy of the ledger and make the transaction history available for download to others per default via network such as by utilizing peer-to-peer protocols.

Content creations that have been registered and licensed in the ledger may be distributed to playback devices for immediate or later playback. Certain playback attributes and other license restrictions may be stored in a playback device's local memory. In additional embodiments, certain license restrictions like playback count and license expiration may be utilized by the playback device to limit playback without having to be updated in the ledger.

For decentralized currencies the aim often is to limit minting or mining of new coins over time, in order to control the number of coins getting into circulation per interval to limit inflation. To control the interval, the challenge to solve is adjusted to the applied processing power, i.e. increase of difficulty as a reaction to a quicker solution. The decentralized digital ledger system typically is not limited in this way as inflation is not a concern. Instead, a more active system with more users and miners can create more issued per time. Hash challenge difficulty would likely not have to vary much except for possible increases to maintain security due to increased computing power. In this sense, the control of inflation can be different from a currency system because the issuing of a number of additional different works does not typically devalue other creations that have already been registered, unlike with currency.

In several embodiments, the right or ability to register a media work into the blockchain ledger is represented by a work registration token that is earned by finding solutions to a hash challenge (e.g., the hash challenge required to close a block). Each solution may reward the solver with work registration tokens, where the number of tokens (RN) granted per solution is configurable as an aspect of regulating the rate at which works can be registered into the blockchain ledger. The reward can be a single token, fraction thereof, or multiple.

For example, if the frequency at which solutions are being found should be decreased, the number of tokens RN granted can be increased allowing more works to be registered with less work, resulting in less mining and a lower frequency. If the frequency at which solutions are being found should be increased, the number of tokens RN granted can be decreased

Similar to the hash challenge in bitcoin the adjustment can be automated by changing it in accordance with a targeted frequency of closing a block. A higher frequency will have more overhead but is quicker to secure the transactions, which is important to verify a license transfer for immediate consumption or play count validation. It can also depend on the length of a typical asset where the verification of a feature film with 15 minutes may be acceptable.

In several embodiments, this can be an alternative to adjusting the difficulty of the hash challenge itself. A work registration token may be represented as a unique value and associated with a private key holder by publishing the public key. One token grants the ability to register one work into the blockchain ledger. Fractional tokens can be combined and a combination of token quantities resulting in more than one result in a residual token quantity that can be used to issue other. This is similar to combining blockchain transaction values to match a desired transaction value.

In a number of embodiments, parallel ledger systems may exist and either work together or be indexed alongside each other. The licensed creations may not be interchangeable and devices could look into several different databases for works based on a number of filters including, but not limited to, creations from similar regions, different content owners, and/or creation times. The decentralized ledger may work with external web services or individual clients to provide information about the ledger including, but not limited to, creation contents, recommendations, ratings, and discovery.

Where discussions herein may refer to an owner, creator, or user performing certain actions with respect to a digital ledger or processes involving digital ledgers, one skilled in the art will recognize that such actions may be performed by and through a device such as a workstation, desktop computer, mobile device, laptop, tablet, and/or playback devices such as those discussed above. Various devices that participate in a decentralized digital ledger system may be referred to as nodes. Further, these actions may be conducted in processes such as those discussed further below and implemented by processors configured by applications stored in memory to perform all or part of those processes. While a variety of decentralized digital ledger systems are described, the specific components utilized within a decentralized ledger system and the manner in which ledgers are stored and maintained may vary in accordance with the requirements of specific applications. Blockchain management device systems that can be utilized in decentralized digital ledger systems in accordance with various embodiments of the invention are discussed further below.

In an exemplary embodiment, a blockchain management device that can be used to create and/or modify a decentralized digital ledger in accordance with embodiments of the invention. The blockchain management device can includes a processor, network interface, network input/output, system bus, and memory. Memory includes a ledger creation application, ledger modification application, and ledger block closing application.

A decentralized digital ledger system may also include additional blockchain management devices with components similar to blockchain management device. While a specific architecture of a blockchain management device is discussed, blockchain management devices in accordance with embodiments of the invention may utilize any of a variety of architectures as appropriate to the particular application. Content playback devices that may utilize a digital ledger in accordance with embodiments of the invention are discussed above.

In an exemplary embodiment, a playback device is a platform that can be used to enforce restrictions mandated by the creator of a piece of content (a media work) and encoded in the blockchain and play the content in accordance with the restrictions. In addition, granting the playback device the ability to play back a particular piece of content by a creator can include a requirement and determination that this playback device or category of playback device is capable of playback of the piece of content. It can also represent a public promise that this platform and piece of content can be combined, given the proper license.

Playback devices may be used to display and consume different media types, including, but not limited to: audio (Stereo, Multi-channel Surround), video (2-Dimensional, 3-Dimensional) Augmented Reality (AR), and/or Virtual Reality (VR), text, images, metadata, and applications, but may also be extended to digital titles that certify ownership in other things, such as real estate properties, art and intellectual property. The manifestation of the right can be converted into a digital asset, e.g., such as by being scanned and digitally signed that is used as the digital assets the license is assigned to.

A platform may be a software playback application or a hardware device incorporating a software playback application. In a number of embodiments a platform is identified by a hash performed over the executable code of the software program that facilitates playback and/or ledger modification. In other embodiments, other characteristics of a software application or hardware device and/or information stored on a hardware device can be utilized to generate an identifier or hash of the platform. Playback of a piece of content may be enabled by a key that entitles a specific software version, or by a generalized platform key that enables only a group of device versions. In this case the creator trusts another entity (such as a company developing a software media player) to conform to requirements. This trust may be established with legal agreements, standards (that prescribe robustness rules as described above) and/or from reputation. In several embodiments of the invention the platform license cannot be revoked, in order to guarantee an immutable connection with the platform that a licensee can exercise and to foster trust by the consumer that the ability to use the content is long lasting. However, in further embodiments, if the security of the platform becomes compromised however, future assets may impose different requirements.

In still further embodiments, the platform may enforce license terms that are not registered in the ledger and agreed on with the platform or creator. However, they don't need to be standardized for all participants in the system, although a de-facto standard is helpful to foster adoption. In still further embodiments, certain license terms may not necessarily be registered in the ledger but are part of the player limitations. For example, enabling HDCP during playback or using a secure video path including a trusted execution environment can be restrictions inherent to the player.

In further still embodiments, a pruned blockchain ledger is stored on the playback device instead of the entire chain of blocks referencing all the way back to the genesis block. The use of pruned blockchain allows for fast loading and processing times, especially during a verification step that examines the trail of ownership of a creation from the first registration until the current potential transaction. A blockchain can be pruned by removing transactions that are no longer relevant and/or required, such as play count transactions (excluding the most recent), license transfer transactions (excluding the most recent), and/or expired licenses. If removing transactions changes a block's hash solution, any link to that block may need to be regenerated.

While a variety of playback device systems are described above, other playback devices incorporating any of a variety of architectures and/or hardware enabling the utilization of a decentralized digital ledger system in accordance with various embodiments of the invention. For example, in certain embodiments, a copy of the ledger may be stored locally in the playback device and utilized when the playback device has no connection to other nodes in the ledger system. These periods are typically limited to enforce connection to the latest updated ledger.

In many embodiments, a distributed network of blockchain management devices and playback devices process and synchronize the blockchain by consensus across multiple POPs (points of presence) across geographic regions or globally. The devices may respond to queries from other devices in the network in a peer-to-peer nature to validate entitlement of users, devices and/or content. In further embodiments, operators of blockchain management devices may be paid or offered credit towards various services, monetarily through a universal currency, or other incentives that could be used for rewards such as, but not limited to, purchasing of content from the content owners associated with this network. Payment may be conducted using the device or a secondary mechanism, such as through a payment service like PayPal or Bitcoin. In many embodiments, the processing or mining of blockchain solutions done by a blockchain management device yields the right to register and license a creation instead of a direct monetary reward.

In an exemplary embodiment, a fundamental structure of a decentralized blockchain ledger includes blocks which are linked together to form a blockchain. Each block in the blockchain contains a reference to the previous block in the chain, with the exception of the genesis block which is the first block created and contains no reference. Ledger blocks contain similar components but may vary in size due to the amount of transactions that are recorded within each block. In a number of environments, the block size can exceed one megabyte.

In additional embodiments, assets in a blockchain are represented by a hash (sometimes referred to as a cryptographic hash), or output of another data operation that is difficult to reverse to recover the input even when the output is known, and would be virtually unique to each creation being registered. The use of a database listing meta data of creations with their respective hashes can aide in the search for creations in the blockchain. In certain embodiments, this database is stored within the blockchain itself. In certain other embodiments, the database is stored externally from the blockchain and referenced by methods including, but not limited to, links to other blocks in different blockchains, hard drive sector locations, and/or URL addresses.

In still further embodiments, meta data relating to the registered creation can be identified in the registration itself such as, but not limited to, cover art for movies, artist information for music, URL links to download the content, and/or methods that allow for the unlocking of potential future content.

In an exemplary embodiment, transactions represent various types of restrictions and operations concerning a media work and can be stored in a block as entries, each having a transaction identifier (ID). As will be discussed further below, one or more transactions may be grouped for entry into a block before the block is closed. Where a description below indicates that a user or creator enters a transaction, the transaction may be entered by a device or node in the decentralized digital system controlled by that user or creator. A transaction may be digitally signed using a private key over all or a portion of the contents of the transaction.

Many potential actions may be represented as a transaction that can be recorded in the ledger as described further above. Some of these transactions include, but are not limited to, issuing of a license, sub-licensing or a creation, and/or platform enablement, play count, verification of ownership of a license. Many embodiments include registering a media work into the blockchain as a transaction. In further embodiments, the creator signs a transaction that identifies the asset issued by this creator, the playback device, external license, and/or license conditions and makes this public in the ledger. In several embodiments, the signing key is the same key as used for the creation of the asset or others enabled by that key to allow sub-licensing. Sublicensing enables another public key to issue licenses. The issuance is then public and can be tracked and billed additional sublicense restrictions could be included in or referenced by the ledger in order to limit the amount and frequency with smart contracts that match agreements between the creator and licensee. Sublicenses could be video distribution operators, including cable, IPTV, satellite and internet platforms that manage, distribute a stream of digital assets, including entertainment content. The signing ensures cryptographically that the creator is the only one issuing granting direct to the work or enabling others. In several embodiments, the public key matching the private signing key is also securely published in the ledger.

Another potential type of transaction is a transfer which occurs when one licensee transfers their license to another person using the decentralized ledger. In many embodiments, implementation of different licensing models is available including, but not limited to: sale, rental, pay-per-view, and/or re-sale of individual licenses for second-hand markets. In a number of embodiments, there are limits placed on the amount of transactions allowed which may simulate a more marketplace style of environment.

In still further embodiments, the ledger that is designed to act as a locker for digital assets may also include relevant transactions with existing ledgers, including other currency blockchains. The benefits of such a system are to enable an easier start and penetration of the system as the decentralized ledger can participate in an existing updated system that already has regular issuing of blocks and distributed consensus on a time stamping service. In yet still further embodiments, to include the decentralized ledger with another blockchain, the transactions can be hashed and the hash included in the other ledger and documented fully elsewhere. This location can be found using the hash in a public database or specified separately using a URL (uniform resource locator) included in the transaction.

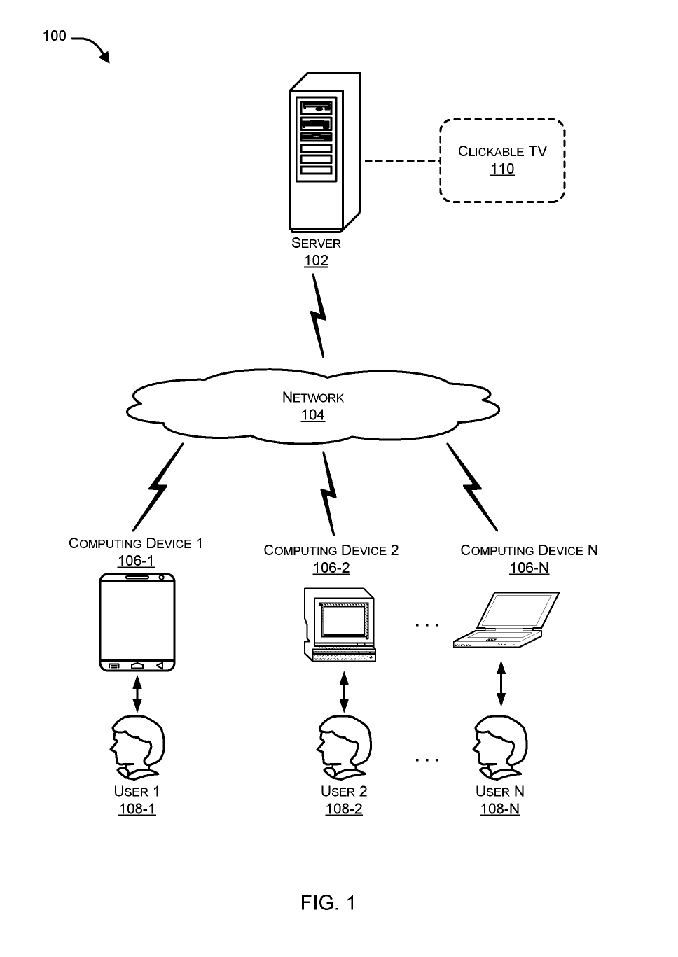

FIG. 1 illustrates a network implementation of a proposed clickable TV, in accordance with an exemplary embodiment of the present disclosure. It would be appreciated that aspects of the present disclosure can be applied to a variety of network architectures, all of which are well within the scope of the present disclosure.

In an aspect, network architecture of the present disclosure can include a proposed clickable TV having/connected with one or more Internet of Things (IoT) devices. In a typical network architecture of the present disclosure can include a plurality of network devices such as transmitter, receivers, and/or transceivers that may include one or more IoT devices.

As used herein, the IoT devices can be a device that includes sensing and/or control functionality as well as a WiFi™ transceiver radio or interface, a Bluetooth™ transceiver radio or interface, a Zigbee™ transceiver radio or interface, an Ultra-Wideband (UWB) transceiver radio or interface, a WiFi-Direct transceiver radio or interface, a Bluetooth™ Low Energy (BLE) transceiver radio or interface, and/or any other wireless network transceiver radio or interface that allows the IoT device to communicate with a wide area network and with one or more other devices. In some embodiments, an IoT device does not include a cellular network transceiver radio or interface, and thus may not be configured to directly communicate with a cellular network. In some embodiments, an IoT device may include a cellular transceiver radio, and may be configured to communicate with a cellular network using the cellular network transceiver radio.

IoT devices may include home automation network devices that allow a user to access, control, and/or configure various home appliances located within the user's home (e.g., a television, radio, light, fan, humidifier, sensor, microwave, iron, and/or the like), or outside of the user's home (e.g., exterior motion sensors, exterior lighting, garage door openers, sprinkler systems, or the like). Network device may include a home automation switch that may be coupled with a home appliance. In some embodiments, network devices may be used in other environments, such as a business, a school, an establishment, a park, or any place that can support a local area network to enable communication with network devices. For example, a network device can allow a user to access, control, and/or configure devices, such as office-related devices (e.g., copy machine, printer, fax machine, or the like), audio and/or video related devices (e.g., a receiver, a speaker, a projector, a DVD player, a television, or the like), media-playback devices (e.g., a compact disc player, a CD player, or the like), computing devices (e.g., a home computer, a laptop computer, a tablet, a personal digital assistant (PDA), a computing device, a wearable device, or the like), lighting devices (e.g., a lamp, recessed lighting, or the like), devices associated with a security system, devices associated with an alarm system, devices that can be operated in an automobile (e.g., radio devices, navigation devices), and/or the like.

A user may communicate with the network devices using an access device that may include any human-to-machine interface with network connection capability that allows access to a network. For example, the access device may include a stand-alone interface (e.g., a cellular telephone, a smartphone, a home computer, a laptop computer, a tablet, a personal digital assistant (PDA), a computing device, a wearable device such as a smart watch, a wall panel, a keypad, or the like), an interface that is built into an appliance or other device e.g., a television, a refrigerator, a security system, a game console, a browser, or the like), a speech or gesture interface (e.g., a KinectTM sensor, a WiimoteTM, or the like), an IoT device interface (e.g., an Internet enabled device such as a wall switch, a control interface, or other suitable interface), or the like. In some embodiments, the access device may include a cellular or other broadband network transceiver radio or interface, and may be configured to communicate with a cellular or other broadband network using the cellular or broadband network transceiver radio. In some embodiments, the access device may not include a cellular network transceiver radio or interface.

User may interact with the network devices using an application, a web browser, a proprietary program, or any other program executed and operated by the access device. In some embodiments, the access device may communicate directly with the network devices (e.g., communication signal). For example, the access device may communicate directly with network devices using Zigbee™ signals, Bluetooth™ signals, WiFi™ signals, infrared (IR) signals, UWB signals, WiFi-Direct signals, BLE signals, sound frequency signals, or the like. In some embodiments, the access device may communicate with the network devices via the gateways and/or a cloud network.

Local area network may include a wireless network, a wired network, or a combination of a wired and wireless network. A wireless network may include any wireless interface or combination of wireless interfaces (e.g., Zigbee™, Bluetooth™, WiFi™, IR, UWB, WiFi-Direct, BLE, cellular, Long-Term Evolution (LTE), WiMax™, or the like). A wired network may include any wired interface (e.g., fiber, Ethernet, powerline, Ethernet over coaxial cable, digital signal line (DSL), or the like). The wired and/or wireless networks may be implemented using various routers, access points, bridges, gateways, or the like, to connect devices in the local area network. For example, the local area network may include gateway and gateway. Gateway can provide communication capabilities to network devices and/or access device via radio signals in order to provide communication, location, and/or other services to the devices. The gateway is directly connected to the external network and may provide other gateways and devices in the local area network with access to the external network. The gateway may be designated as a primary gateway.

The network access provided by gateway may be of any type of network familiar to those skilled in the art that can support data communications using any of a variety of commercially-available protocols. For example, gateways may provide wireless communication capabilities for the local area network using particular communications protocols, such as WiFi™ (e.g., IEEE 802.11 family standards, or other wireless communication technologies, or any combination thereof). Using the communications protocol(s), the gateways may provide radio frequencies on which wireless enabled devices in the local area network can communicate. A gateway may also be referred to as a base station, an access point, Node B, Evolved Node B (eNodeB), access point base station, a Femtocell, home base station, home Node B, home eNodeB, or the like.

Gateways may include a router, a modem, a range extending device, and/or any other device that provides network access among one or more computing devices and/or external networks. For example, gateway may include a router or access point or a range extending device. Examples of range extending devices may include a wireless range extender, a wireless repeater, or the like.

A router gateway may include access point and router functionality, and may further include an Ethernet switch and/or a modem. For example, a router gateway may receive and forward data packets among different networks. When a data packet is received, the router gateway may read identification information (e.g., a media access control (MAC) address) in the packet to determine the intended destination for the packet. The router gateway may then access information in a routing table or routing policy, and may direct the packet to the next network or device in the transmission path of the packet. The data packet may be forwarded from one gateway to another through the computer networks until the packet is received at the intended destination.

Referring now to FIG. 1, in an embodiment, FIG. 1 indicates a network 100 implementation of a proposed clickable TV 110. Although the present subject matter is explained considering that the proposed clickable TV implemented as an application on a server 102, it may be understood that the proposed clickable TV 110 may also be implemented in a variety of computing systems, such as a laptop computer, a desktop computer, a notebook, a workstation, a server, a network server, a cloud-based environment and the like. It would be appreciated that the proposed clickable TV 110 may be accessed by multiple users 108-1, 108-2 . . . 108-N (collectively referred to as users 108, and individually referred to as the user 108 hereinafter), through one or more computing devices 106-1, 106-2 . . . 106-N (collectively referred to as computing devices 106 hereinafter), or applications residing on the computing devices 106. In an aspect, the proposed safety device 110 can be operatively coupled to a website and so be operable from any Internet enabled computing device 106. Examples of the computing devices 106 may include, but are not limited to, a portable computer, a personal digital assistant, a handheld device, and a workstation. The computing devices 106 are communicatively coupled to the proposed safety device 110 through a network 104. It may be also understood that the proposed clickable TV 110 can be a wearable device having wearable technology, wearables, fashionable technology, wearable devices, tech togs, or fashion electronics embedded in them. The proposed clickable TV 110 can be smart electronic devices (electronic device with microcontrollers) that can be worn on the body as implant or accessories.

In one implementation, the network 104 can be a wireless network, a wired network or a combination thereof. The network 104 can be implemented as one of the different types of networks, such as intranet, local area network (LAN), wide area network (WAN), the internet, and the like. Further, the network 104 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 104 can include a variety of network devices, including routers, bridges, servers, computing devices, storage devices, and the like.

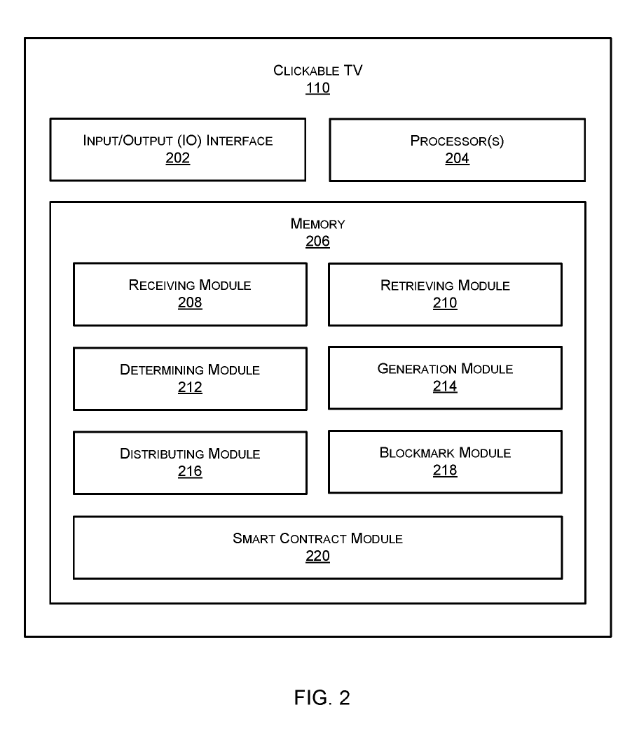

FIG. 2 illustrates exemplary functional modules 200 of the proposed clickable TV 110, in accordance with an exemplary embodiment of the present disclosure. In one embodiment, the proposed clickable TV 110 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions stored in the memory 206.

The I/O interface 204 may include a variety of software and hardware interfaces, for example, a web interface, a graphical user interface, and the like. The I/O interface 204 may allow the proposed safety device 110 to interact with a user directly or through the client devices 104. Further, the I/O interface 204 may enable the proposed safety device 110 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules, routines, programs, objects, components, data structures, etc., which perform particular tasks or implement particular abstract data types. In one implementation, the memory 206 may include a receiving module 208, a retrieving module 210, a determining module 212, a generation module 214, and a distributing module 216, a bookmark module 218, and a smart contract module 220.

In an exemplary embodiment, the proposed clickable TV to facilitate clickable link embedded in a multimedia content using a decentralized blockchain ledger is provided. The proposed clickable TV can include a receiving module 208 to receive the multimedia content that includes the clickable link embedded in the multimedia content, a retrieving module 210 to retrieve one or more web links upon clicking of the clickable link that enables a user to view an advertised product and/or enables activation of one or more tokens, a determining module 212 to determine one or more interaction events performed by the user while viewing the advertised product and/or while retailing using the one or more tokens, a generation module 214 to generate a registration entry associated with the one or more interaction events for addition to the decentralized blockchain ledger, and a distributing module 216 to distribute the registration entry in a blockchain to a plurality of nodes in the decentralized blockchain ledger management system.

In an aspect, the registration entry is generated based on the one or more interaction events. In another aspect, the registration entry is secured using a combination of the one or more tokens and one or more encryption keys ensuring privacy and security of the user's data and an advertiser's data.

In an aspect, the clickable link enables the user to request information associated with the advertised product from the advertiser.

In an aspect, an advertiser pays a publisher based at least on the one or more interaction events. In another aspect, an advertiser updates the one or more web links and/or the advertised product based at least on the one or more interaction events.

In an aspect, the clickable link embedded in the multimedia content is configured to operate in a LIVE environment and/or a desktop virtual reality (DVR) environment.

In an aspect, the bookmark module 218 enables the user can bookmark the web links that enables the user to view the advertised product.

In an aspect, the one or more interaction events are associated with at least a click stream data.

In an aspect, the one or more interaction events are associated with at least an e-commerce sales data.

In an aspect, the system and method according to the present disclosure can enable to determine one or more paths of the one or more tokens to match with e-commerce sales in order to determine return on investment (ROI).

In an aspect, the one or more tokens are cryptocurrencies. In another aspect, the one or more tokens have an associated pre-defined value.

In an aspect, the one or more tokens are transferable. In another aspect, the one or more tokens are sellable on open exchanges and are usable to purchase goods and services through clickable link embedded in the multimedia content.

In an aspect, the one or more web links are associated with and/or are hosted by advertisers. In another aspect, the multimedia content is provided by the advertiser.

In an aspect, the smart contract module 220 enables to perform digital facilitation, verification, or enforcement of negotiation or performance of a contract between the use and advertisers and/or a publisher using a smart contract.

In an exemplary embodiment, a system having a clickable link embedding device (not shown) to embed a clickable link in a multimedia content, and a computing device 112 to facilitate clickable link embedded in the multimedia content using a decentralized blockchain ledger is provided. The computing device 112 can receives the multimedia content that includes the clickable link embedded in the multimedia content, retrieves one or more web links upon clicking of the clickable link that enables a user to view an advertised product and/or enables activation of one or more tokens, determines one or more interaction events, performed by the user, while viewing the advertised product and/or while retailing using the one or more tokens, generates a registration entry associated with the one or more interaction events for addition to the decentralized blockchain ledger, and distributes the registration entry in a blockchain to a plurality of nodes in the decentralized blockchain ledger management system.

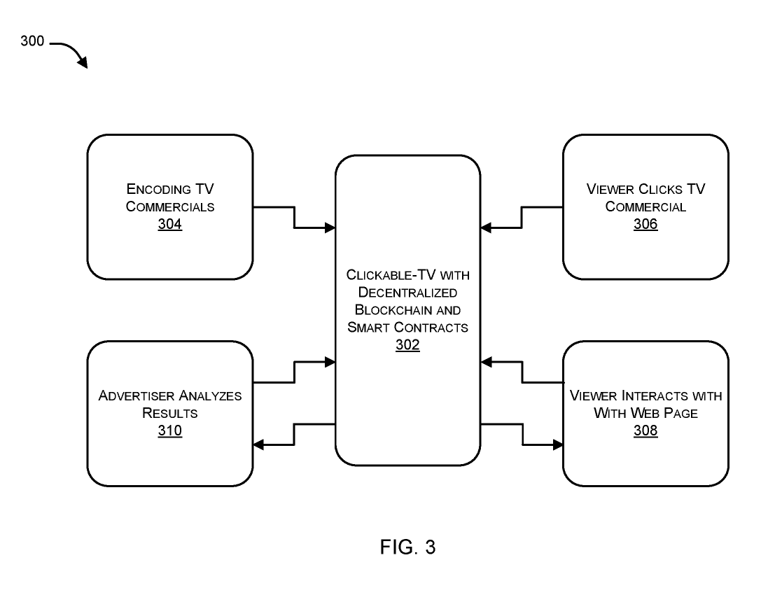

FIG. 3 illustrates exemplary working 300 of the proposed clickable TV, in accordance with an exemplary embodiment of the present disclosure.

While using the conventional advertising techniques, advertisers are particularly warry using new technologies that do not provide the most secure methods available to protect their customer data. Since ClickableTV enables e-commerce purchases from mobile phones, tablets, or browsers clicks, the potential exists for security breaches that will leave customers vulnerable.

In an embodiment, the present invention takes a two-pronged approach to safeguarding advertisers from e-commerce breaches. First by implementing smart contracts, the tokens embedded into digital media presentations will not be linked back to the advertiser's agreement, and second by acting/operating much like an Internet affiliated marketing program (similar to Fat Wallet or Commission Junction) since each ClickableTV token will be deposited with an advertiser's e-commerce website.

In an exemplary embodiment, the present invention allows viewers to click a commercial from either a mobile phone, tablet or Internet browser and either buy the advertised product, or request more information from the advertiser.

In an exemplary embodiment, the present invention allows to install a server with an Multichannel video programming distributor (MPVD) provider (like Comcast), a Virtual MVPD provider (like Hulu), or an Streaming or Subscription Video on Demand (SVOD) (like YouTube) that converts one or more tokens (already embedded in the digital television media) into a ClickableTV moment that viewers can activate by clicking the commercial on their mobile device, tablet or browser.

In contrast to the conventional techniques of advertisement, the present invention by linking the tokens to the clickable moments ensures that advertisers are only paying for its advertising and that they are in control of who sees their campaigns' results.

Referring now to FIG. 3, as shown each entity in the proposed system interacts with the central block 302 clickable TV with decentralized blockchain and smart contracts.

It may be appreciated that the central block 302 clickable TV with decentralized blockchain and smart contracts may be an open-source, public, blockchain-based distributed computing platform featuring smart contract (scripting) functionality, similar to Ethereum. It provides a decentralized Turing-complete virtual machine, the Ethereum Virtual Machine (EVM), which can execute scripts using an international network of public nodes. Ethereum also provides a cryptocurrency token called “ether”, which can be transferred between accounts and used to compensate participant nodes for computations performed. “Gas”, an internal transaction pricing mechanism, is used to mitigate spam and allocate resources on the network. In an example, the value token of the Ethereum blockchain is called ether. It is listed under the code ETH and traded on cryptocurrency exchanges, and the Greek uppercase Xi character (Ξ) is generally used for its currency symbol. It is also used to pay for transaction fees and computational services on the Ethereum network.

At block 304 advertiser's link web pages to TV commercials using any of the existing techniques for embedding a link into multimedia contents. In an example, the advertiser may use existing techniques provided on “Extreme Reach”, “encoding.com”, “final cut pro X” and the like. Such clickable link embedded videos are provided/displayed to the user in the form of advertisements/commercials via Block 302. In an exemplary embodiment, the clickable TV is integrated with premium video content and works in LIVE and DVR environments.

At block 306, the viewers/users, based on their interest, can click on the clickable link embedded in the videos. As soon as the Block 302 identifies that the user has clicked on the clickable link from the video, the user is either directed to an advertiser's site with which the clickable link is associated or can fetch the web pages from the advertiser's site. The block 302 utilizes ethereum and any other cryptocurrencies as token.

At block 308, the viewers interact with web page and/or URL is/are retrieved from advertiser's server and sent to the viewer in real-time. While the interaction the user can purchase the products advertised and/or seek/request further information about the advertise product form then advertiser.

At step 310, the advertiser analyzes results/interactions of the viewers with web page and/or URL. The advertisers can pay for viewer impressions using methods already in place today. In an exemplary embodiment, based on responses using advertisers can update their linked web pages during their television campaigns.

In an exemplary embodiment, the advertisers can create complex advertising campaigns from one office or offices around the world. Through the blockchain they can rest assured that their data is secure no matter if one or a thousand employees review the results. The blockchain contains clickable TV response data and media plans. Blockchain protects against unknown actors stealing advertisers media buy plans and results.

In an exemplary embodiment, the viewers can bookmark ads to their favorites list after activation.

In an exemplary embodiment, the Clickable TV security function as the random calculations of the blockchain guarantee an advertiser they are only paying for what was clicked.

In an exemplary embodiment, the present invention enables to install a server configuration into each cable company in order to initiate the token exchange that creates Clickable TV.

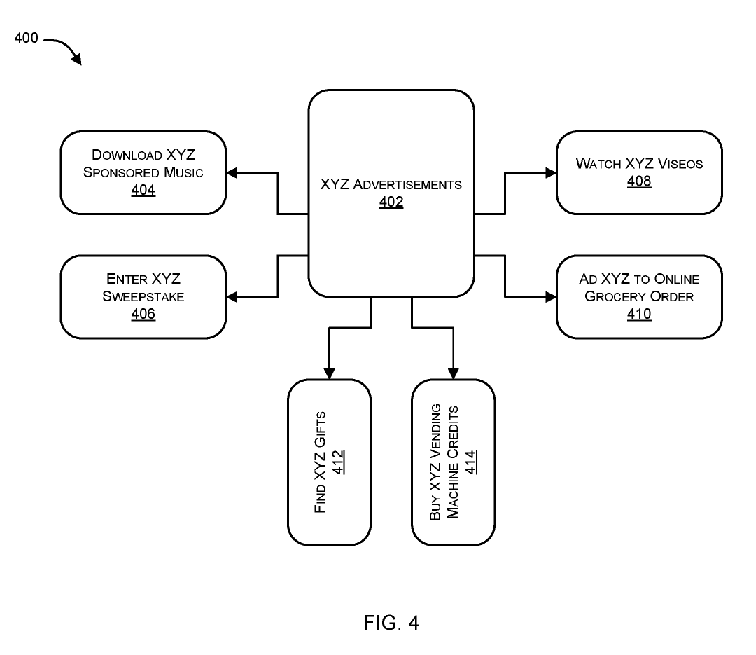

FIG. 4 400 illustrates exemplary links of provided by the proposed clickable TV for any digital asset/multimedia content, in accordance with an exemplary embodiment of the present disclosure. In an exemplary embodiment, an advertisement “XYZ” 402 having clickable links embedded in are displayed to the user. It may be appreciated that, there can be a plurality of clickable links embedded in the advertisement “XYZ” 402.

The user upon interest can select any of the plurality of clickable links embedded in the advertisement “XYZ” 402. For example, the user can select a link that may direct the user on a web page providing an option to download XYZ sponsored music 404, or the user can select a link that may direct the user on a web page providing an option to enter sweepstake, or the user can select a link that may direct the user on a web page providing an option to watch videos associated with XYZ 408 either on advertiser's site or on YouTube, or the user can select a link that may direct the user on a web page providing an option toad the XYZ to an online grocery order 410, or the user can select a link that may direct the user on a web page providing an option to find XYZ gifts 412, or the user can select a link that may direct the user on a web page providing an option to buy XYZ vending machine credits 414.

In an exemplary embodiment, it may be appreciated that, upon clicking on the clickable links, the user is displayed with the new web page that may either fetched from the advertiser's site or pre-stored in the database associated with the clickable advertisements.

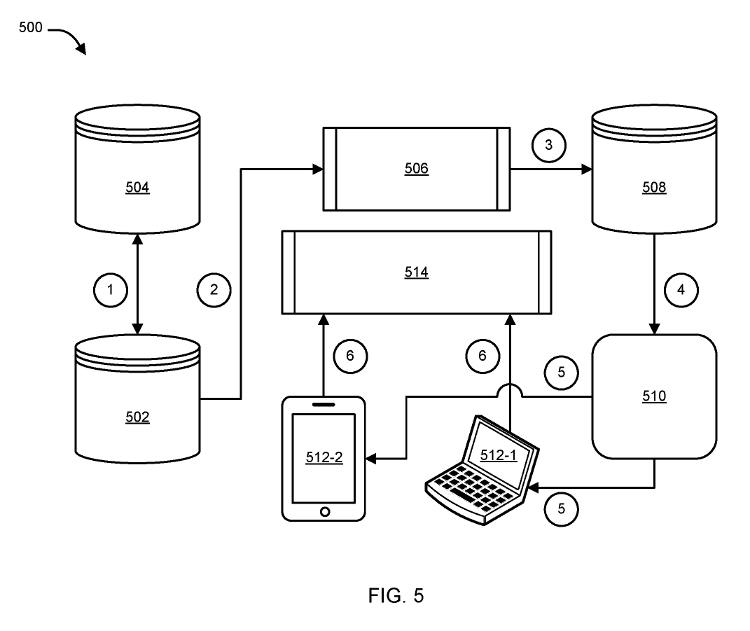

FIG. 5 500 illustrates an exemplary installation of the proposed clickable TV, in accordance with an exemplary embodiment of the present disclosure. In an embodiment, the present invention enables to install a server configuration into each cable company in order to initiate the token exchange that creates Clickable TV. It may be appreciated that the tokens that are part of each Clickable TV server can be pre-sold to the advertisers and/or users/viewers.

As shown, in step 1, a company database 502 can provide a URL link mapping to advertisement and accordingly a unique ID is allocated to such clickable advertisement. Such unique ID is selected from a database 504 having a pre-stored set of unique IDs. In step 2, the process 506 of insertion of clickable links into the advertisement is continued. In step 3, post processing 508 upon insertion of clickable links into the advertisement is performed. In step 4, the embedded videos are provided to the content providers 510 or ISPs. In step 5, the embedded videos are provided/transmitted to the user on their personal devices such as but not limited to computers 512-1 or mobile phones 512-2. In step 6, the viewers interact with web page and/or URL is/are retrieved from advertiser's server and sent to the viewer in real-time. While the interaction the user can purchase the products advertised and/or seek/request further information about the advertise product form then advertiser.

The advertiser analyzes results/interactions 514 of the viewers with web page and/or URL. The advertisers can pay for viewer impressions using methods already in place today. In an exemplary embodiment, based on responses using advertisers can update their linked web pages during their television campaigns.

In an exemplary embodiment, the advertisers can create complex advertising campaigns from one office or offices around the world. Through the blockchain they can rest assured that their data is secure no matter if one or a thousand employees review the results. The blockchain contains clickable TV response data and media plans. Blockchain protects against unknown actors stealing advertisers media buy plans and results.

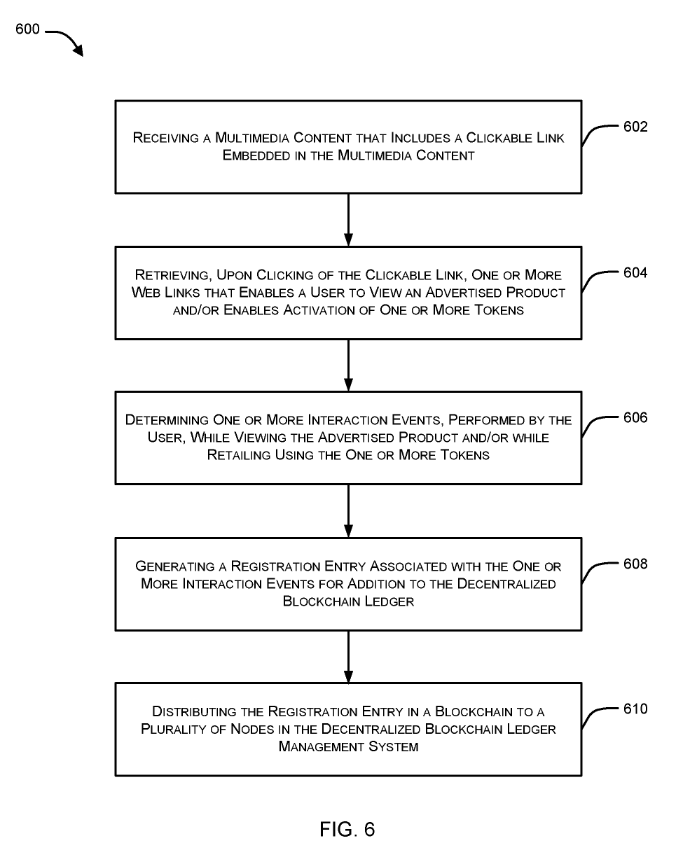

FIG. 6 illustrates an exemplary flow diagram representing method performed by the proposed clickable TV, in accordance with an exemplary embodiment of the present disclosure. The method may be described in the general context of computer executable instructions. Generally, computer executable instructions can include routines, programs, objects, components, data structures, procedures, modules, functions, etc., that perform particular functions or implement particular abstract data types. The method 600 may also be practiced in a distributed computing environment where functions are performed by remote processing devices that are linked through a communications network. In a distributed computing environment, computer executable instructions may be located in both local and remote computer storage media, including memory storage devices.

The order in which the method is described is not intended to be construed as a limitation, and any number of the described method blocks can be combined in any order to implement the method or alternate methods. Additionally, individual blocks may be deleted from the method without departing from the spirit and scope of the subject matter described herein. Furthermore, the method can be implemented in any suitable hardware, software, firmware, or combination thereof. However, for ease of explanation, in the embodiments described below, the method may be considered to be implemented in the above proposed clickable TV 110.

In an embodiment, a computer-implemented method of facilitating clickable link embedded in a multimedia content using a decentralized blockchain ledger is provided.

At block 602, the multimedia content that includes the clickable link embedded in the multimedia content is received on a user device.

At block 604, one or more web links are retrieved upon clicking of the clickable link that enables a user to view an advertised product and/or enables activation of one or more tokens.

At block 606, one or more interaction events performed by the user are determined while viewing the advertised product and/or while retailing using the one or more tokens.

At block 608, a registration entry associated with the one or more interaction events is determined for addition to the decentralized blockchain ledger.

At block 610, the registration entry is distributed in a blockchain to a plurality of nodes in the decentralized blockchain ledger management system.

Although the proposed system has been elaborated as above to include all the main modules, it is completely possible that actual implementations may include only a part of the proposed modules or a combination of those or a division of those into sub-modules in various combinations across multiple devices that can be operatively coupled with each other, including in the cloud. Further the modules can be configured in any sequence to achieve objectives elaborated. Also, it can be appreciated that proposed system can be configured in a computing device or across a plurality of computing devices operatively connected with each other, wherein the computing devices can be any of a computer, a laptop, a smartphone, an Internet enabled mobile device and the like. All such modifications and embodiments are completely within the scope of the present disclosure.

As used herein, and unless the context dictates otherwise, the term “coupled to” is intended to include both direct coupling (in which two elements that are coupled to each other or in contact each other) and indirect coupling (in which at least one additional element is located between the two elements). Therefore, the terms “coupled to” and “coupled with” are used synonymously. Within the context of this document terms “coupled to” and “coupled with” are also used euphemistically to mean “communicatively coupled with” over a network, where two or more devices are able to exchange data with each other over the network, possibly via one or more intermediary device.

Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

While some embodiments of the present disclosure have been illustrated and described, those are completely exemplary in nature. The disclosure is not limited to the embodiments as elaborated herein only and it would be apparent to those skilled in the art that numerous modifications besides those already described are possible without departing from the inventive concepts herein. All such modifications, changes, variations, substitutions, and equivalents are completely within the scope of the present disclosure. The inventive subject matter, therefore, is not to be restricted except in the spirit of the appended claims.

What is claimed is:

1. A computer-implemented method of facilitating clickable link embedded in a multimedia content using a decentralized blockchain ledger, the computer implemented method comprising:
receiving the multimedia content that includes the clickable link embedded in the multimedia content;
retrieving, upon clicking of the clickable link, one or more web links that enables a user to view an advertised product and/or enables activation of one or more tokens;
determining one or more interaction events, performed by the user, while viewing the advertised product and/or while retailing using the one or more tokens;
generating a registration entry associated with the one or more interaction events for addition to the decentralized blockchain ledger; and
distributing the registration entry in a blockchain to a plurality of nodes in the decentralized blockchain ledger management system.

2. The computer-implemented method of claim 1, wherein the registration entry is generated based on the one or more interaction events.

3. The computer-implemented method of claim 1, wherein the registration entry is secured using a combination of the one or more tokens and one or more encryption keys ensuring privacy and security of the user's data and an advertiser's data.

4. The computer-implemented method of claim 1, wherein the clickable link enables the user to request information associated with the advertised product from the advertiser.

5. The computer-implemented method of claim 1, wherein an advertiser pays a publisher based at least on the one or more interaction events.

6. The computer-implemented method of claim 1, wherein an advertiser analyzes the interactions based on the number of clicks, impressions on the advertised web pages.

7. The computer-implemented method of claim 1, wherein an advertiser updates the one or more web links and/or the advertised product based at least on the one or more interaction events.

8. The computer-implemented method of claim 1, wherein the clickable link embedded in the multimedia content is configured to operate in a LIVE environment and/or a desktop virtual reality (DVR) environment.

9. The computer-implemented method of claim 1, wherein the computer-implemented method enables the user to bookmark the web links that enables the user to view the advertised product.

10. The computer-implemented method of claim 1, wherein the one or more interaction events are associated with at least a click stream data.

11. The computer-implemented method of claim 1, wherein the one or more interaction events are associated with at least an e-commerce sales data.

12. The computer-implemented method of claim 1, further comprising: determining one or more paths of the one or more tokens to match with e-commerce sales in order to determine return on investment (ROI).

13. The computer-implemented method of claim 1, wherein the one or more tokens are cryptocurrencies.

14. The computer-implemented method of claim 1, wherein the cryptocurrencies can be any or combination of Ether, Bitcoin, Ripple, Dash, Ripple, and Litecoin.

15. The computer-implemented method of claim 1, wherein the one or more tokens have an associated pre-defined value.

16. The computer-implemented method of claim 1, wherein the one or more tokens are transferable.

17. The computer-implemented method of claim 1, wherein the one or more tokens are sellable on open exchanges and are usable to purchase goods and services through clickable link embedded in the multimedia content.

18. The computer-implemented method of claim 1, wherein the one or more web links are associated with and/or are hosted by advertisers.

19. The computer-implemented method of claim 1, wherein the multimedia content is provided by the advertiser.

20. The computer-implemented method of claim 1, further comprising: performing, using a smart contract, digitally facilitation, verification, or enforcement of negotiation or performance of a contract between the use and advertisers and/or a publisher.

21. A computing device to facilitate clickable link embedded in a multimedia content using a decentralized blockchain ledger, the computing device comprising:
a receiving module configured to receive the multimedia content that includes the clickable link embedded in the multimedia content;
a retrieving module configured to retrieve, upon clicking of the clickable link, one or more web links that enables a user to view an advertised product and/or enables activation of one or more tokens;
a determining module configured to determine one or more interaction events, performed by the user, while viewing the advertised product and/or while retailing using the one or more tokens;
a generation module configure to generate a registration entry associated with the one or more interaction events for addition to the decentralized blockchain ledger; and
a distributing module configured to distribute the registration entry in a blockchain to a plurality of nodes in the decentralized blockchain ledger management system.

22. The computing device of claim 21, wherein the registration entry is generated based on the one or more interaction events.

23. The computing device of claim 21, wherein the registration entry is secured using a combination of the one or more tokens and one or more encryption keys ensuring privacy and security of the user's data and an advertiser's data.

24. The computing device of claim 21, wherein the clickable link enables the user to request information associated with the advertised product from the advertiser.

25. The computing device of claim 21, wherein an advertiser pays a publisher based at least on the one or more interaction events.

26. The computing device of claim 21, wherein an advertiser updates the one or more web links and/or the advertised product based at least on the one or more interaction events.

27. The computing device of claim 21, wherein the clickable link embedded in the multimedia content is configured to operate in a LIVE environment and/or a desktop virtual reality (DVR) environment.

28. The computing device of claim 21 further comprises a bookmark module configured to enable the user to bookmark the web links that enables the user to view the advertised product.

29. The computing device of claim 21, wherein the one or more interaction events are associated with at least a click stream data or are associated with at least an e-commerce sales data.

30. The computing device of claim 21, wherein the determining module is further configured to determine one or more paths of the one or more tokens to match with e-commerce sales in order to determine return on investment (ROI).

31. The computing device of claim 21, wherein the one or more tokens are cryptocurrencies or have an associated pre-defined value.

32. The computing device of claim 21, wherein the one or more tokens are any or combination of transferable, sellable on open exchanges and usable to purchase goods and services through clickable link embedded in the multimedia content.

33. The computing device of claim 21, further comprising: a smart contract module, using a smart contract, configured to digitally facilitation, verification, or enforcement of negotiation or performance of a contract between the use and advertisers and/or a publisher.

34. A system comprising:
a clickable link embedding device configured to embed a clickable link in a multimedia content; and
a computing device to facilitate clickable link embedded in the multimedia content using a decentralized blockchain ledger, the computing device configured to:
receive the multimedia content that includes the clickable link embedded in the multimedia content;
retrieve, upon clicking of the clickable link, one or more web links that enables a user to view an advertised product and/or enables activation of one or more tokens;
determine one or more interaction events, performed by the user, while viewing the advertised product and/or while retailing using the one or more tokens;
generate a registration entry associated with the one or more interaction events for addition to the decentralized blockchain ledger; and
distribute the registration entry in a blockchain to a plurality of nodes in the decentralized blockchain ledger management system.
